(19) United States
(12) Patent Application Publication
(10) Pub. No.: US 2013/0043072 A1
(43) Pub. Date: Feb. 21, 2013

(54) FULL TENSION SWAGED ACSR CONNECTOR

(71) Applicants: Eyass Khansa, Long Beach, CA (US); Luis Sosa, Los Angeles, CA (US)

(72) Inventors: Eyass Khansa, Long Beach, CA (US); Luis Sosa, Los Angeles, CA (US)

(73) Assignee: DMC POWER, INC., Gardena, CA (US)

(21) Appl. No.: 13/274,503

(22) Filed: Oct. 17, 2011

Related U.S. Application Data
(60) Provisional application No. 61/523,530, filed on Aug. 15, 2011.

(51) Int. Cl. H01R 9/00; H01R 43/04

(52) U.S. Cl. 174/74 R; 29/863

(57) ABSTRACT

An improved connector for ACSR cable includes a connector core having an axial bore dimensioned to receive the steel core of the cable. A connector body has a substantially cylindrical outer surface and a substantially cylindrical cavity. A distal portion of the cavity having a first substantially cylindrical inner surface is dimensioned to receive the connector core. A second portion of the cavity proximally adjacent to the distal portion has a substantially cylindrical second inner surface dimensioned to receive the aluminum conductor strands of the cable. The connector body may be configured with one or more additional portions of the cavity having substantially cylindrical inner surfaces with progressively increasing diameters, the number of such portions depending on the size of the cable. The connector body is compressed with a swaging tool at several axially spaced-apart locations to grip the aluminum conductor strands and also to compress the connector core.

### CROSS-REFERENCE TO RELATED APPLICATION

This application claims priority of provisional application No. 61/523,530 filed Aug. 15, 2011.

### BACKGROUND OF THE INVENTION

1. Field of the Invention

This invention relates to the field of power transmission and, more particularly, to connectors for Aluminum Conductor Steel Reinforced (ACSR) full tension cables, which are used in electrical substations and high-tension power transmission lines.

2. Background

ACSR cable is a specific type of high-capacity, high-strength stranded cable typically used in overhead power lines. The outer strands are aluminum, chosen for its excellent conductivity, low weight and low cost. The outer strands surround one or more center strands of steel, which provide the strength required to support the weight of the cable without stretching the ductile aluminum conductor strands. This gives the cable an overall higher tensile strength compared to a cable composed of only aluminum conductor strands.

Connectors play a critical role in the efficiency and reliability of power transmission systems. Aluminum cables used for overhead transmission lines require connectors for splices and dead end assemblies. Commonly assigned U.S. Pat. No. 7,874,881 discloses a full tension fitting for all-aluminum cables. While this fitting could be used with ACSR cable, the resulting connection would not withstand the same high tensile load that the cable itself is designed to withstand. Thus, there is a need for a full tension connector adapted for use with ACSR cable.

### SUMMARY OF INVENTION

The present invention provides an improved connector for ACSR cable with a connector core having an axial bore dimensioned to receive the steel core of the cable. A connector body has a substantially cylindrical outer surface and a substantially cylindrical cavity. A distal portion of the cavity having a first substantially cylindrical inner surface is dimensioned to receive the connector core. A second portion of the cavity proximally adjacent to the distal portion has a substantially cylindrical second inner surface dimensioned to receive the aluminum conductor strands of the cable. The connector body may be configured with one or more additional portions of the cavity having substantially cylindrical inner surfaces with progressively increasing diameters, the number of such portions depending on the size of the cable. The connector body is compressed with a swaging tool at several axially spaced-apart locations to grip the aluminum conductor strands and also to compress the connector core, thereby gripping the steel core of the cable.

### BRIEF DESCRIPTION OF THE DRAWINGS

FIG. 1 is a cross-sectional view of an ACSR cable.

FIG. 2 is a side elevation view of a connector in accordance with an embodiment of the present invention installed on a cable.

FIG. 3 is a cross-sectional view through line A-A of the connector and cable shown in FIG. 2.

FIG. 4 is a perspective view of a first type of connector core.

FIG. 5 is an end view of the connector core shown in FIG. 4.

FIG. 6 is a perspective view of a second type of connector core.

FIG. 7 is an end view of the connector core shown in FIG. 6.

FIG. 8 is a perspective view of a third type of connector core.

FIG. 9 is an end view of the connector core shown in FIG. 8.

FIG. 10 is a cross-sectional view of the connector body shown in FIG. 2.

FIG. 11 illustrates the swaging regions on the connector body.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

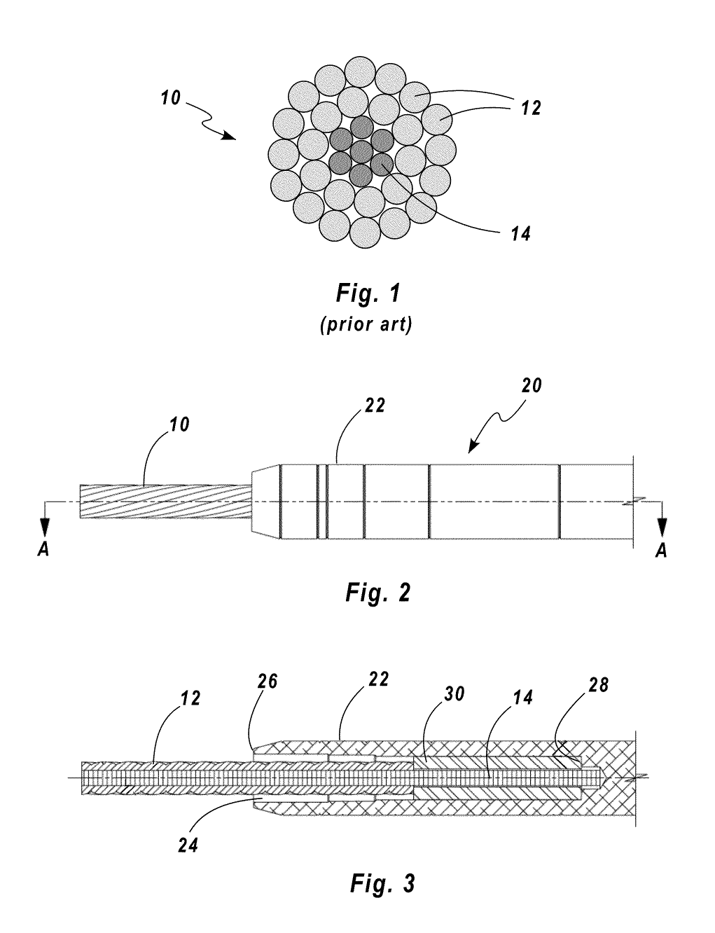

A common type of ACSR cable 10 is illustrated in FIG. 1. This particular type of cable, having an industry designation 26/7, has twenty-six outer strands of aluminum conductor 12 surrounding a core 14 comprising seven strands of steel. As explained above, the steel core is a primary contributor to the tensile strength of cable 10. A tubular swaged connector, such as disclosed in U.S. Pat. No. 7,874,881, would directly grip only the outer aluminum strands. Thus, a different style of connector is needed to take advantage of the increased tensile strength afforded by the steel core of ACSR cable.

An ACSR connector 20 in accordance with one embodiment of the present invention is shown in FIGS. 2 and 3. The connector body 22 has a substantially cylindrical outer surface and has a bored-out central cavity 24 extending from the proximal end 26 to an annular seating surface 28. A connector core 30 is inserted into cavity 24 and rests against seating surface 28. The aluminum strands at the end of cable 10 are removed for a distance approximately equal to the length of the connector core. The end of cable 10 is inserted into cavity 24 with the steel core 14 fitting into a central axial bore in the connector core 30 and the cut-back ends of the aluminum strands enclosed within the proximal portion of cavity 24. Once assembled in this fashion, the connector 20 is secured to the end of cable 10 with multiple swages as described below.

Connector 20 may be configured either as a splice connector with a tubular body receiving a cable at each end or as a full tension dead end having a suitable structural coupling at the distal end of the body. Connector body 22 may be fabricated with a suitable aluminum alloy, such as 3003-H18.

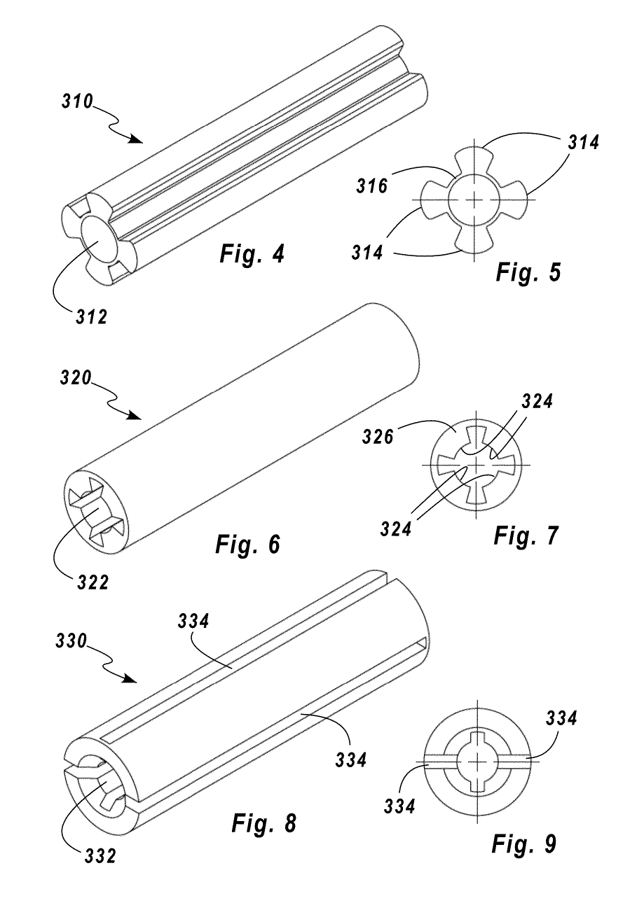

Connector core 30 may be configured in accordance with one of several different designs. One such design is illustrated in FIGS. 4 and 5. Connector core 310 is configured as a tube with a central axial bore 312 and, in cross-section, spokes 314 radiating outwardly from an annular region 316 surrounding the central bore. Another connector core design is illustrated in FIGS. 6 and 7. Connector core 320 is configured as a tube with a central axial bore 322 and, in cross-section, spokes 324 radiating inwardly from circular outer portion 326. Yet another connector core design is illustrated in FIGS. 8 and 9. Connector core 330 is generally tubular in configuration with a central axial bore 332 and a plurality of axially extending slots 334 similar to a collet chuck. The scope of the invention is not limited to these particular configurations. Other configurations of connector cores may be employed to serve the purpose of gripping the steel core of the cable when the connector body is swaged around the connector core. The connector core may have aluminum oxide or other suitable grit bonded onto the inner surface of the axial bore to increase the mechanical grip on the steel core of the cable. Alternatively, the inner surface of the axial bore may be machined with female threads, circumferential teeth or other surface finishes to enhance the connector core's grip on the steel core of the cable. The connector core may be fabricated with suitable aluminum or steel alloys, such as 6061-T6 aluminum or tool steel.

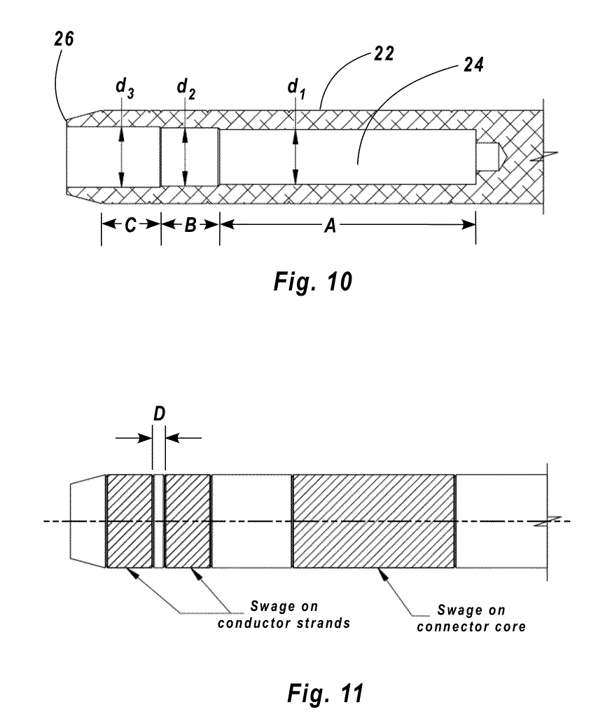

FIG. 10 is a cross-sectional view of connector body 22 illustrating its internal structure. In portion A of the connector body, where the connector core is inserted, cavity 24 has a diameter d₁, which is only slightly larger than the outer diameter of the connector core. Moving from portion A towards the proximal end 26 of the connector body, the diameter of the cavity is increased in steps to transfer the swaging load uniformly to all aluminum strand layers of the ACSR cable. Thus, in portion B, cavity 24 has a diameter d₂, which is larger than d₁; and in portion C, cavity 24 has a diameter d₃, which is larger than d₂. The number of steps may be fewer or greater and will generally be determined by the size of the cable.

Referring now to FIG. 11, after the cable and connector core have been inserted into cavity 24, the outer connector body is swaged at several locations to secure it uniformly around the aluminum strands of the cable and around the connector core that grips the steel strands of the cable. The swaging operation is preferably performed using the 360° Radial Swage Tool manufactured by DMC Power, Inc. of Gardena, Calif. The connector body is swaged within portion A to secure the connector core and the steel core of the cable. Multiple overlapped swages may be needed to fully secure the cable core. The connector body is also swaged within portions B and C to secure the aluminum conductor strands. The compression force is increased approximately 3% to 20% at each portion as the internal diameter of the connector body decreases. There is a space or gap, denoted as D, between any consecutive swages on the aluminum strands. This space, in the range of about 0.1″ to 0.25″, allows the aluminum strands to flare out behind each swage and lock the cable behind the swage when it is subjected to tensile force. The swage in portion A securing the connector core and the steel core of the cable disposed therein has the primary function of transmitting the tensile load of the cable through the connector, whereas the swages in portions B and C (and any additional portions with further stepped up internal diameters) add to the tensile strength, but also serve the function of establishing electrical conductivity between the cable and the connector.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A connector for an electrical cable having a core of at least one steel strand surrounded by aluminum conductor strands comprising:
a connector core having an axial bore dimensioned to receive the steel core of the cable;
a connector body having an opening at a proximal end thereof and a substantially cylindrical outer surface, the opening communicating with a substantially cylindrical cavity having a distal portion dimensioned to receive the connector core, said distal portion having a first substantially cylindrical inner surface with an inside diameter d₁, said cavity further having a second portion proximally adjacent to the distal portion having a substantially cylindrical second inner surface with an inside diameter d₂ dimensioned to receive the aluminum conductor strands, wherein d₂≧d₁.

2. The connector of claim 1 wherein the cavity further has a third portion proximally adjacent to the second portion having a substantially cylindrical third inner surface with an inside diameter d₃, wherein d₃>d₂.

3. The connector of claim 1 wherein the connector body is configured as a splice.

4. The connector of claim 1 wherein the connector body is configured as a dead end.

5. The connector of claim 1 wherein an axial cross-section of the connector core has a plurality of spokes radiating outwardly from an annular region surrounding the bore.

6. The connector of claim 1 wherein an axial cross-section of the connector core has a plurality of spokes radiating inwardly from a circular outer perimeter.

7. The connector of claim 1 wherein the connector core is generally tubular with a plurality of axially extending slots.

8. A method of attaching the connector of claim 1 to an electrical cable having a steel core surrounded by aluminum connector strands comprising:
inserting the steel core into the bore in the connector core;
inserting the connector core into the distal portion of the cavity in the connector body;
inserting the aluminum conductor strands into the second portion of the cavity;
compressing the outer surface of the connector body surrounding the distal portion of the cavity with at least a first compression force;
compressing the outer surface of the connector body surrounding the second portion of the cavity with a second compression force.

9. The method of claim 8 wherein the steps of compressing are performed using a swaging tool.

10. A method of attaching the connector of claim 2 to an electrical cable having a steel core surrounded by aluminum connector strands comprising:
inserting the steel core into the bore in the connector core;
inserting the connector core into the distal portion of the cavity in the connector body;
inserting the aluminum conductor strands into the second and third portions of the cavity;
compressing the outer surface of the connector body surrounding the distal portion of the cavity with at least a first compression force;
compressing the outer surface of the connector body surrounding the second portion of the cavity with a second compression force;
compressing the outer surface of the connector body surrounding the third portion of the cavity with a third compression force.

11. The method of claim 10 wherein the steps of compressing are performed using a swaging tool.
